(19) United States
(12) Patent Application Publication
(10) Pub. No.: US 2006/0286208 A1
(43) Pub. Date: Dec. 21, 2006

(54) Methods for producing protein partial hydrolysates and infant formulas containing the same

(76) Inventors: Nagendra Rangavajla, Newburgh, IN (US); Win-Chin Chiang, Newburgh, IN (US); Lily Kelly, Evansville, IN (US); Debra J. Nichols, Topeka, KS (US)

Correspondence Address: NELSON MULLINS RILEY & SCARBOROUGH, LLP, MERIDIAN, SUITE 1700, 1320 MAIN STREET, COLUMBIA, SC, 29201, US

(21) Appl. No.: 11/142,543

(22) Filed: Jun. 1, 2005

(51) Int. Cl. A23C 9/12

(52) U.S. Cl. 426/34

(57) ABSTRACT

The present invention relates to a process for preparing a protein partial hydrolysate. The process involves intermixing a solution of whey protein, casein and water; adjusting the temperature and pH of the solution, adding Protease N to the solution, and allowing the solution to hydrolyze for a period of time so as to obtain a degree of hydrolysis between about 4% and 10%. The hydrolysis is ended by subjecting the solution to enzyme deactivation.

### FIELD OF INVENTION

The present invention relates to methods for producing protein partial hydrolysates and infant formulas containing the same.

### BACKGROUND

Food allergy is an immunologically mediated clinical syndrome that develops after the ingestion of a dietary product. The adverse reaction that accompanies a food allergy is often an immediate immunoglobulin E (IgE) mediated reaction, otherwise known as food protein allergy. Host, A., et al., Dietary Products Used in Infants for Treatment and Prevention of Food Allergy, Arch. Dis. Child 81:80-84 (1999). Symptoms of food protein allergy include angioedema, urticaria, exzema, asthma, rhinitis, conjunctivitis, vomiting, or anaphylaxis.

Cow's milk allergy is the most common food protein allergy in young children and occurs in about 2% to 3% of all infants. Sampson, H. A., Food Allergy. Part 1: Immunopathogenesis and Clinical Disorders, J Allergy Clin Immunol. 103:717-728 (1999). One possible explanation for the prevalence of cow's milk allergy among infants is that intact cow's milk protein, which is found in all conventional infant formulas, is the earliest and most common food allergen to which infants are exposed. In addition, infants may be especially susceptible to cow's milk allergies because their intestinal mucosa have a greater permeability to incompletely digested macromolecules than do adults. Moran R., Effects of Prolonged Exposure to Partially Hydrolyzed Milk Protein, J. Pediatr. 121:S90-S4 (1992).

While there is no known treatment that can completely cure cow's milk allergy, it may be possible to prevent or lessen cow's milk and other allergies in infants through the consumption of hydrolyzed protein formulas. It has been shown that the consumption of infant formulas having partially and extensively hydrolyzed in place of conventional formulas having only intact proteins may reduce the risk of future allergies in infants. Id. Thus, if an infant has a family history of allergies, consumption of hydrolyzed protein formulas may reduce the risk of that child developing an allergy in the future.

Hydrolyzed protein formulas can be characterized as extensively hydrolyzed or partially hydrolyzed. Extensively hydrolyzed protein-containing infant formulas (EHF) are based on cow's milk, but the proteins have been treated with enzymes to break down most of the proteins that cause allergy-related symptoms. One example of a commercially-available EHF is Enfamil® Nutramigen®. It is a casein-based hypoallergenic infant formula for term infants who are sensitive to intact proteins in cow's milk and soy formulas. Partially hydrolyzed protein-containing infant formulas (PHF), on the other hand, have been treated with enzymes to break down only some of the milk proteins.

Ideally, any infant formula, including PHF, should simulate human milk as closely as possible. In human milk, there are two main proteins, whey protein and casein. Whey protein typically composes about 60% of the protein in human milk, while casein typically composes about 40%. Lonnerdal, B., Biochemistry and Physiological Functions of Human Milk Proteins, Am. J. Clin. Nutr. 42:1299-1317 (1985).

Various methods for producing PHFs have been disclosed, but none provide the benefits of the present invention. U.S. Patent App. No. 20030072863 to Hayasawa, et al. relates to a method for manufacturing a protein hydrolysate, characterized in that the rate of hydrolysis is between 30 and 45%. The method does not, however, disclose a method for preparing a partially hydrolyzed protein of both whey protein and casein and does not disclose a degree of hydrolysis between about 4 and 10%.

U.S. Pat. No. 5,744,179 to Shimamura, et al relates to a method for manufacturing a low-phosphorus whey protein hydrolysate. The patent does not disclose a method for preparing a partial hydrolysate that involves hydrolyzing both whey protein and casein. Additionally, the reference does not disclose the degree of hydrolysis that the present invention discloses.

U.S. Pat. No. 6,395,508 to Shimamura, et al. relates to a method for producing a peptide mixture. The method, however, does not disclose the hydrolysis of both whey protein and casein, and does not disclose the degree of hydrolysis of the present application.

U.S. Pat. No. 4,918,008 to Gauri, et al. discusses the preparation of a protein hydrolysate. The process does not disclose the hydrolysis of both whey protein and casein and does not disclose the degree of hydrolysis of the present application.

U.S. Pat. No. 6,465,209 to Blinkovsky, et al. relates to a method for producing a protein hydrolysate. The method, however, allows hydrolysis to occur only long enough to obtain a degree of hydrolysis between about 35 and 90% and most preferably between 60 and 70%. Additionally, the method does not disclose the hydrolysis of a combination of whey protein and casein using Protease N enzyme.

### SUMMARY OF THE INVENTION

The present invention is directed to a novel method for preparing a protein partial hydrolysate, the method involving intermixing a solution of whey protein, casein and water; raising the temperature of the solution to between about 50° C. and 60° C.; adjusting the pH of the solution to and maintaining the pH between about 6.5 and 8; adding Protease N to the solution; allowing the solution to hydrolyze for a period of time so as to obtain a degree of hydrolysis between about 4% and 10%; and subjecting the solution to enzyme deactivation.

The present invention is also directed to a novel method for preparing an infant formula containing a protein partial hydrolysate, the method comprising intermixing a solution of whey protein, casein and water, wherein the ratio of whey protein:casein is about 60:40; raising the temperature of the solution to between about 50° C. and 60° C.; maintaining the pH of the solution between about 6.5 and 8; adding Protease N to the solution; allowing the solution to hydrolyze for a period of time so as to obtain a degree of hydrolysis between about 4% and 10%; subjecting the solution to enzyme deactivation; and combining the protein partial hydrolysate with a carbohydrate source and a lipid source to form an infant formula.

Among the several advantages found to be achieved by the present invention is that the present process provides a method for hydrolyzing a combination of whey protein and casein, a combination that is similar to the proteins found in human milk. Additionally, use of Protease N as a proteolytic enzyme and the particular degree of hydrolysis achieved by the present invention provide a protein partial hydrolysate with acceptable taste and emulsification properties and a protein partial hydrolysate that induces a lesser priming effect for IgG antibody response than does intact cow's milk.

### DETAILED DESCRIPTION OF THE PREFERRED EMBODIMENTS

Reference now will be made in detail to the embodiments of the invention, one or more examples of which are set forth below. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used on another embodiment to yield a still further embodiment.

Thus, it is intended that the present invention cover such modifications and variations as come within the scope of the appended claims and their equivalents. Other objects, features and aspects of the present invention are disclosed in or are obvious from the following detailed description. It is to be understood by one of ordinary skill in the art that the present discussion is a description of exemplary embodiments only, and is not intended as limiting the broader aspects of the present invention.

### Definitions

As used herein, the terms “nutritional supplement” or “supplement” refer to a dietary additive that provides a nourishing amount of protein and carbohydrate.

The terms “degree of hydrolysis” mean the extent to which peptide bonds are broken by an enzymatic hydrolysis reaction. The measurement shows the number of specific peptide bonds broken in hydrolysis as a percent of the total number of specific peptide bonds present in the intact protein.

The term “probiotic” means a microorganism that exerts beneficial effects on the health of the host.

As used herein, the term “prebiotic” means a non-digestible food ingredient that beneficially affects the host by selectively stimulating the growth and/or activity of one or a limited number of bacteria in the colon that can improve the health of the host.

As used herein, the term “infant” means a human that is less than about one year old.

As used herein, the term “infant formula” means a composition that satisfies the nutrient requirements of an infant by being a substitute for human milk. In the United States, the contents of an infant formula are dictated by the federal regulations set forth at 21 C.F.R. Sections 100, 106, and 107. These regulations define macronutrient, vitamin, mineral, and other ingredient levels in an effort to stimulate the nutritional and other properties of human breast milk.

### Invention

In accordance with the present invention, a novel method for preparing a protein partial hydrolysate has been discovered. Briefly, the method involves intermixing a solution of whey protein, casein and water; adjusting the temperature and pH of the solution, adding Protease N to the solution, and allowing the solution to hydrolyze for a period of time so as to obtain a degree of hydrolysis between about 4% and 10%. The hydrolysis is ended by subjecting the solution to enzyme deactivation.

A novel method for preparing an infant formula containing a protein partial hydrolysate has also been discovered. Briefly, involves intermixing a solution of whey protein, casein and water; adjusting the temperature and pH of the solution, adding Protease N to the solution, and allowing the solution to hydrolyze for a period of time so as to obtain a degree of hydrolysis between about 4% and 10%. The hydrolysis is ended by subjecting the solution to thermal deactivation. The protein partial hydrolysate is then combined with a carbohydrate source and a lipid source to form an infant formula.

In one embodiment of the invention, the method provides a whey protein:casein ratio that is similar to that found in human breast milk. In a particular embodiment, the ratio of whey protein:casein is between about 50:50 and 70:30. In another embodiment, the ratio of casein:whey protein is about 60:40.

The whey protein used in the present invention may be derived from any source known in the art. In one embodiment, the whey protein may be sourced from a raw whey obtained from sweet cheese manufacturing, from whey protein concentrate (WPC) which is obtained by ultrafiltration (UF whey), by ion exchange and/or electrophoresis (ED whey), or from whey isolate that has been treated to reduce the lactose content of the whey.

The casein used in the present invention may also be derived from any source known in the art. For example, the casein can be either acid casein or non-fat milk solids (NFM).

Both the whey protein and the casein may be diluted or reconstituted to solutions containing between about 20% and 25% total solids, and between about 40% and 50% protein on a dry basis.

In the method of the present invention, the proteins are hydrolyzed using a proteolytic enzyme, Protease N. Protease N “Amano” is commercially available from Amano Enzyme U.S.A. Co., Ltd., Elgin, Ill. Protease N is a proteolytic enzyme preparation that is derived from the bacterial species Bacillus subtilis. The protease powder is specified as “not less than 150,000 units/g”, meaning that one unit of Protease N is the amount of enzyme which produces an amino acid equivalent to 100 micrograms of tyrosine for 60 minutes at a pH of 7.0. In an embodiment of the present method, Protease N is used at levels of about 0.5% to about 1.0% by weight of the total protein being hydrolyzed.

The protein hydrolysis by Protease N is typically conducted at a temperature of about 50° C. to about 60° C. In a particular embodiment of the invention, the temperature is maintained at about 55° C. The hydrolysis occurs for a period of time so as to obtain a degree of hydrolysis between about 4% and 10%. In a particular embodiment, hydrolysis occurs for a period of time so as to obtain a degree of hydrolysis between about 6% and 9%. In another embodiment, hydrolysis occurs for a period of time so as to obtain a degree of hydrolysis of about 7.5%. This level of hydrolysis may take between about one half hour to about 3 hours.

A constant pH should be maintained during hydrolysis. In the method of the present invention, the pH is adjusted to and maintained between about 6.5 and 8. In a particular embodiment, the pH is maintained at about 7.0.

In order to maintain the optimal pH of the solution of whey protein, casein, water and Protease N, a caustic solution of sodium hydroxide and/or potassium hydroxide can be used to adjust the pH during hydrolysis. If sodium hydroxide is used to adjust the pH, the amount of sodium hydroxide added to the solution should be controlled to the level that it comprises less than about 0.3% of the total solid in the finished protein hydrolysate. A 10% potassium hydroxide solution can also be used to adjust the pH of the solution to the desired value, either before the enzyme is added or during the hydrolysis process in order to maintain the optimal pH.

The amount of caustic solution added to the solution during the protein hydrolysis can be controlled by a pH-stat or by adding the caustic solution continuously and proportionally. The hydrolysate can be manufactured by standard batch processes or by continuous processes.

To better ensure the consistent quality of the protein partial hydrolysate, the hydrolysate is subjected to enzyme deactivation to end the hydrolysis process. The enzyme deactivation step may include a heat treatment at a temperature of about 82° C. for about 10 minutes. Alternatively, the enzyme can be deactivated by heating the solution to a temperature of about 92° C. for about 5 seconds. After enzyme deactivation is complete, the hydrolysate can be stored in a liquid state at a temperature lower than 10° C.

In an embodiment of the present invention, the liquid partial protein hydrolysate made according to the methods described herein can be used as is and blended with other ingredients in a method to make an infant formula. Alternatively, the liquid partial protein hydrolysate can be subjected to spray drying. The spray-dried hydrolysate can then be incorporated into an infant formula. In yet another embodiment, the liquid partial hydrolysate can be concentrated by evaporation and then spray dried. Again, the spray-dried hydrolysate can be incorporated into an infant formula. An infant formula having the described partially hydrolyzed proteins can be formulated using any of the methods of infant formula formulation known in the art.

In the present invention, the infant formula into which the protein partial hydrolysate can be supplemented may be nutritionally complete and typically contains suitable types and amounts of lipid, carbohydrate, protein, vitamins and minerals. The amount of lipid or fat typically can vary from about 3 to about 7 g/100 kcal. The amount of protein typically can vary from about 1 to about 5 g/100 kcal. The amount of carbohydrate typically can vary from about 8 to about 12 g/100 kcal. Lipid sources can be any known in the art, including vegetable oils such as palm oil, soybean oil, palmolein, coconut oil, medium chain triglyceride oil, high oleic sunflower oil, high oleic safflower oil, and the like. Carbohydrate sources can be any known in the art, including lactose, glucose, corn syrup solids, maltodextrins, sucrose, starch, rice syrup solids, and the like.

In one particular embodiment of the invention, the carbohydrate component of the infant formula is comprised of 100% lactose. In another embodiment, the carbohydrate component comprises between about 0% and 60% lactose. In another embodiment of the present invention, the carbohydrate component comprises between about 15% and 55% lactose. In yet another embodiment of the present invention, the carbohydrate component comprises between about 20% and 30% lactose. In these embodiments, the remaining source of carbohydrates may be any carbohydrate known in the art. In an embodiment, the carbohydrate component comprises about 25% lactose and about 75% corn syrup solids.

The protein partial hydrolysate can be combined with various other ingredients to create an infant formula. In one embodiment, one or more of the ingredients may include a probiotic. Any probiotic known in the art will be acceptable in this embodiment. In a particular embodiment, the probiotic is chosen from the group consisting of Lactobacillus and Bifidobacterium.

In another embodiment of the invention, one or more prebiotics can be combined with the protein partial hydrolysate and various other ingredients to create an infant formula. Any prebiotic known in the art will be acceptable in this embodiment. Prebiotics of the present invention may include lactulose, galacto-oligosaccharide, fructo-oligosaccharide, isomalto-oligosaccharide, soybean oligosaccharides, lactosucrose, xylo-oligosacchairde, and gentio-oligosaccharides.

In other embodiments of the present invention, the partial hydrolysate infant formula of the present invention may contain other components such as long chain polyunsaturated fatty acids (LCPUFA). Suitable LCPUFAs include, but are not limited to, α-linoleic acid, γ-linoleic acid, linoleic acid, linolenic acid, eicosapentaenoic acid (EPA), arachidonic (ARA) and docosahexaenoic acid (DHA). In an embodiment, the infant formula contains the partial hydrolysate of the present invention and DHA. In another embodiment, the infant formula contains the partial hydrolysate of the present invention and ARA. In yet another embodiment, the infant formula contains the partial hydrolysate of the present invention and both DHA and ARA.

In one embodiment, both DHA and ARA are incorporated into a partial hydrolysate infant formula of the present invention. In this embodiment, the weight ratio of ARA:DHA is typically from about 1:3 to about 9:1. Alternatively, this ratio can be from about 1:2 to about 4:1. In yet another alternative, the ratio can be from about 2:3 to about 2:1. In one particular embodiment the ratio is about 2:1.

The effective amount of DHA in an embodiment of the present invention is typically from about 3 mg per kg of body weight per day to about 150 mg per kg of body weight per day. In one embodiment of the invention, the amount of DHA is from about 6 mg per kg of body weight per day to about 100 mg per kg of body weight per day. In another embodiment the amount is from about 10 mg per kg of body weight per day to about 60 mg per kg of body weight per day. In yet another embodiment the amount is from about 15 mg per kg of body weight per day to about 30 mg per kg of body weight per day.

The amount of DHA in infant formulas for use with the present invention typically varies from about 5 mg/100 kcal to about 80 mg/100 kcal. In one embodiment of the present invention the amount of DHA varies from about 10 mg/100 kcal to about 50 mg/100 kcal; and in another embodiment it varies from about 15 mg/100 kcal to about 20 mg/100 kcal. In a particular embodiment of the present invention, the amount of DHA is about 17 mg/100 kcal.

The effective amount of ARA in an embodiment of the present invention is typically from about 5 mg per kg of body weight per day to about 150 mg per kg of body weight per day. In one embodiment of this invention, the amount of ARA varies from about 10 mg per kg of body weight per day to about 120 mg per kg of body weight per day. In another embodiment, the amount of ARA varies from about 15 mg per kg of body weight per day to about 90 mg per kg of body weight per day. In yet another embodiment, the amount varies from about 20 mg per kg of body weight per day to about 60 mg per kg of body weight per day.

The amount of ARA in infant formulas for use with the present invention typically varies from about 10 mg/100 kcal to about 100 mg/100 kcal. In one embodiment of the present invention, the amount of ARA varies from about 15 mg/100 kcal to about 70 mg/100 kcal. In another embodiment the amount of ARA varies from about 20 mg/100 kcal to about 40 mg/100 kcal. In a particular embodiment of the present invention, the amount of ARA is about 34 mg/100 kcal.

DHA and ARA can be supplemented into the partially hydrolyzed infant formula of the present invention using standard techniques known in the art. For example, DHA and ARA can be added to the formula by replacing an equivalent amount of an oil, such as high oleic sunflower oil, normally present in the formula. As another example, the oils containing DHA and ARA can be added to the formula by replacing an equivalent amount of the rest of the overall fat blend normally present in the formula without DHA and ARA.

The source of DHA and ARA can be any source known in the art. In an embodiment of the present invention, sources of DHA and ARA are single cell oils as taught in U.S. Pat. Nos. 5,374,567; 5,550,156; and 5,397,591, the disclosures of which are incorporated herein in their entirety by reference. However, the present invention is not limited to only such oils. DHA and ARA can be in natural or refined form.

In one embodiment, the source of DHA and ARA is substantially free of eicosapentaenoic acid (EPA). For example, in one embodiment of the present invention the infant formula contains less than about 16 mg EPA/100 kcal; in another embodiment less than about 10 mg EPA/100 kcal; and in yet another embodiment less than about 5 mg EPA/100 kcal. One particular embodiment contains substantially no EPA. Another embodiment is free of EPA in that even trace amounts of EPA are absent from the formula.

In an embodiment of the present invention, the partial protein hydrolysate made according to the methods described herein can be incorporated into a nutritional supplement. The partial protein hydrolysate can be used in liquid form and blended with other ingredients to make a liquid nutritional supplement. Alternatively, the partial protein hydrolysate can be spray-dried and incorporated into a powdered nutritional supplement. A nutritional supplement having the described partially hydrolyzed proteins can be formulated using any of the methods of nutritional supplement formulation known in the art.

The method of the present invention creates a protein partial hydrolysate that has a particular molecular weight distribution. This molecular weight distribution has demonstrated acceptable emulsification and taste qualities as compared to other partial hydrolysates found in the prior art. In addition, the particular molecular weight distribution has been shown to induce a lesser serum IgG antibody effect than intact milk protein.

Size exclusion chromatography (SEC) was used to determine the molecular weight distribution of the hydrolysate peptides created by the presently-described hydrolysis process. In an embodiment, the partial hydrolysate of the invention has the range of molecular weight distribution shown in Table 1.

TABLE 1

| Molar Mass | |
|---|---|
| (in Daltons) | % Molecular Weight Distribution |
| <500 | 11-20 |
| 500-1000 | 25-38 |
| 1000-2000 | 27-30 |
| 2000-3000 | 8-16 |
| 3000-5000 | 3-10 |
| >5000 | 2-11 |

In another embodiment, the partial hydrolysate of the invention has the molecular weight distribution as shown in Table 2.

TABLE 2

| Molar Mass | |
|---|---|
| (in Daltons) | % Molecular Weight Distribution |
| <500 | 17 |
| 500-1000 | 35.1 |
| 1000-2000 | 30.9 |
| 2000-3000 | 9.6 |
| 3000-5000 | 4.2 |
| >5000 | 2.8 |

The following examples describe various embodiments of the present invention. Other embodiments within the scope of the claims herein will be apparent to one skilled in the art from consideration of the specification or practice of the invention as disclosed herein. It is intended that the specification, together with the examples, be considered to be exemplary only, with the scope and spirit of the invention being indicated by the claims which follow the examples. In the examples, all percentages are given on a weight basis unless otherwise indicated.

### EXAMPLE 1

This example illustrates a method for producing a protein partial hydrolysate. Initially, 60.3 kg non-milk solids (milk powder) and 37.4 kg whey protein concentrate (60%) were intermixed in a tank containing water at 54° C. The slurry had a total solids content of between 20% and 23%. The pH of the slurry was then measured. Sodium and potassium hydroxide were added to the slurry to adjust the pH of the slurry to 7.0. After adjusting the pH, 0.5 kg of Amano N enzyme was added to the slurry. Following the addition of Amano N to the slurry, the pH was continuously adjusted to a pH of 7.0 using sodium hydroxide and potassium hydroxide. The total amount of sodium hydroxide added to the slurry was 0.3 kg. The total amount of potassium hydroxide added to the slurry was 1.5 kg.

The hydrolysis was permitted to occur for 90 minutes, the time starting with the addition of Amano N enzyme to the slurry. At the end of 90 minutes, the slurry was heat treated to inactivate the enzyme. The heat treatment consisted of raising the temperature of the slurry to 82° C. for 10 minutes. The degree of hydrolysis obtained in this example was between 6% and 9%. The slurry was then cooled and spray dried to obtain a powdered hydrolysate.

### EXAMPLE 2

This example illustrates the priming effect for IgG antibody response of the protein partial hydrolysate obtained in Example 1. Three hundred twenty-three infants were studied in seven pediatric practices located throughout the United States. Subjects were healthy term infants enrolled shortly after birth.

Infants whose mother indicated her intention to breastfeed were assigned to group A. Those infants whose mothers elected not to breastfeed were randomly assigned in double-blind fashion to either group B or C. Infants in group B received an infant formula comprising the protein partial hydrolysate obtained in Example 1. Infants in group C received a commercially available, whey-protein dominant milk-based formula (Enfamil, available from Mead Johnson Co., Evansville, Ind.). Both formulas contained the same amounts of protein, carbohydrate and fat.

Infants were evaluated at monthly intervals up to 4 months of age at all sites, and at 6 and 8 months of age at three of the seven sites. Blood was drawn on admission and at 3, 6 and 8 months of age for detection of serum antibodies to milk. IgE anti-milk protein antibodies were quantified by a biotin-avidin enzyme-linked immunosorbent assay; IgG anti-milk protein antibodies were determined by use of enzyme-linked immunosorbent assay described in Burks, et al. Burks, A. W., et al., Antibody Response to Milk Protein in Pateints with Milk Protein Intolerance Documented by Challenge, J. Allergy Clin. Immunol. 85:921-927 (1990). Additional blood was drawn to measure serum levels of ferritin and hemoglobin and determine hematocrit in the infants who were examined at 8 months of age.

The mean serum concentration of IgG antibodies to milk was comparable in all groups at the time of admission to the study. However, increases in serum IgG antibodies to milk were significantly larger in the group of infants fed formula C than those fed breast milk (group A) or formula B. This lower concentration of IgG antibodies to milk in group B indicates a greater priming effect of intact cow milk protein for IgG antibody responses (group C). Thus, there may be a reduced immunogenic potential of the partially hydrolyzed milk proteins of group B.

At the time of enrollment, no significant differences among the three groups were found in the mean serum concentrations of IgE antibodies to milk. Further there were no significant differences in the IgE levels among the feeding regimens throughout the study. The mean serum ferritin, heatocrit and hemoglobin values were within the normal range at 8 months of age, and no significant differences were found among the three groups.

### EXAMPLE 3

This example illustrates a particular embodiment of an infant formula supplemented with the protein partial hydrolysate prepared according to the process of the present invention.

TABLE 3
Nutrient Information for Infant Formula

| Ingredient | Per 100 kg | |
|---|---|---|
| Lactose | 44.253 | kg |
| Partially Hydrolyzed NFM and WPC | 26.865 | kg |
| solids | | |
| Fat Blend | 26.628 | kg |
| Single Cell ARA and DHA Oil Blend | 0.709 | kg |
| Calcium Carbonate | 0.400 | kg |
| Potassium Chloride | 0.200 | kg |
| Choline Chloride | 0.134 | kg |
| Magnesium Phosphate | 0.110 | kg |
| Calcium Phosphate, tribasic | 0.100 | kg |
| L-Carnitine | 0.010 | kg |
| Ascorbic Acid | 162.900 | g |
| Inositol | 39.887 | g |
| Corn Syrup Solids | 231.281 | g |
| Taurine | 33.875 | g |
| Tocopheryl Acetate | 25.279 | g |
| Vitamin A | 7.871 | g |
| Niacimamide | 6.475 | g |
| Vitamin K₁ | 5.454 | g |
| Calcium Pantothenate | 3.299 | g |
| Vitamin B₁₂ | 2.122 | g |
| Biotin Trituration | 1.608 | g |
| Vitamin D3 | 0.969 | g |
| Riboflavin | 0.755 | g |
| Thiamin HCl | 0.601 | g |
| Pyridoxine HCl | 0.518 | g |
| Folic Acid | 0.122 | g |
| Ferrous Sulfate, Heptahydrate | 49.600 | g |
| Zinc Sulfate | 16.422 | g |
| Sodium Selenite | 0.018 | g |
| Cupric Sulfate | 1.688 | g |
| Manganese Sulfate | 0.239 | g |

All references cited in this specification, including without limitation, all papers, publications, patents, patent applications, presentations, texts, reports, manuscripts, brochures, books, internet postings, journal articles, periodicals, and the like, are hereby incorporated by reference into this specification in their entireties. The discussion of the references herein is intended merely to summarize the assertions made by their authors and no admission is made that any reference constitutes prior art. Applicants reserve the right to challenge the accuracy and pertinence of the cited references

Although preferred embodiments of the invention have been described using specific terms, devices, and methods, such description is for illustrative purposes only. The words used are words of description rather than of limitation. It is to be understood that changes and variations may be made by those of ordinary skill in the art without departing from the spirit or the scope of the present invention, which is set forth in the following claims. In addition, it should be understood that aspects of the various embodiments may be interchanged both in whole or in part. For example, while methods for the production of a sterile liquid infant formula made according to those methods have been exemplified, other uses are contemplated. Therefore, the spirit and scope of the appended claims should not be limited to the description of the preferred versions contained therein.

What is claimed is:

1. A method for preparing a protein partial hydrolysate, the method comprising:
intermixing a solution of whey protein, casein and water, wherein the ratio of whey protein:casein is about 60:40;
raising the temperature of the solution to between about 50° C. and 60° C.;
maintaining the pH of the solution between about 6.5 and 8;
adding Protease N to the solution;
allowing the solution to hydrolyze for a period of time so as to obtain a degree of hydrolysis between about 4% and 10%; and
subjecting the solution to enzyme deactivation.

2. The method according to claim 1, wherein the temperature of the solution is maintained at about 55° C.

3. The method according to claim 1, wherein the pH is maintained at about 7.0.

4. The method according to claim 1, wherein the level of Protease N in the solution is between about 0.5% and 1%, based on the weight of the total protein initially present.

5. The method according to claim 1, wherein the solution is allowed to hydrolyze for a period of time so as to obtain a degree of hydrolysis between about 6% and 9%.

6. The method according to claim 1, wherein the solution is allowed to hydrolyze for a period of time so as to obtain a degree of hydrolysis of about 7.5%.

7. The method according to claim 1, wherein the hydrolysis occurs for about one half hour to about three hours.

8. The method according to claim 1, wherein the enzyme deactivation step comprises raising the temperature of the mixture to between about 80° C. and 84° C. for about 10 minutes.

9. The method according to claim 1, wherein the enzyme deactivation step comprises raising the temperature of the mixture to between about 90° C. and 94° C. for about 5 seconds.

10. The method according to claim 1, wherein the partial hydrolysate is stored in a liquid state at a temperature less than about 10° C.

11. The method according to claim 10, wherein the partial hydrolysate is blended with other ingredients to make an infant formula.

12. The method according to claim 11, wherein the infant formula has a source of carbohydrate and a source of lipid, and wherein the source of carbohydrate comprises about 100% lactose.

13. The method according to claim 11, wherein the infant formula has a source of carbohydrate and a source of lipid, and wherein the source of carbohydrate comprises between about 0% and 60% lactose.

14. The method according to claim 11, wherein the infant formula has a source of carbohydrate and a source of lipid, and wherein the source of carbohydrate comprises between about 15% and 55% lactose.

15. The method according to claim 11, wherein the infant formula has a source of carbohydrate and a source of lipid, and wherein the source of carbohydrate comprises between about 20% and 30% lactose.

16. The method according to claim 11, wherein the infant formula has a source of carbohydrate and a source of lipid, and wherein the source of carbohydrate comprises about 25% lactose and about 75% corn syrup solids.

17. A method for preparing an infant formula containing a protein partial hydrolysate, the method comprising:
intermixing a solution of whey protein, casein and water, wherein the ratio of whey protein:casein is about 60:40;
raising the temperature of the solution to between about 50° C. and 60° C.;
maintaining the pH of the solution between about 6.5 and 8;
adding Protease N to the solution;
allowing the solution to hydrolyze for a period of time so as to obtain a degree of hydrolysis between about 4% and 10%;
subjecting the solution to enzyme deactivation; and
combining the protein partial hydrolysate with a carbohydrate source and a lipid source to form an infant formula.

18. The method according to claim 14, wherein the infant formula additionally comprises vitamins and minerals.

19. The method according to claim 14, wherein the infant formula additionally comprises a probiotic.

20. The method according to claim 14, wherein the infant formula additionally comprises a prebiotic.

21. The method according to claim 14, wherein the infant formula additionally comprises at least one LCPUFA.

22. The method according to claim 18, wherein the LCPUFA comprises DHA and/or ARA.

23. An infant formula comprising a protein source, a carbohydrate source, and a lipid source, wherein the protein source is prepared according to the process of claim 1.
